(19) United States
(12) Patent Application Publication
(10) Pub. No.: US 2013/0031782 A1
(43) Pub. Date: Feb. 7, 2013

(54) METHOD FOR PRODUCING A PISTON FOR AN INTERNAL COMBUSTION ENGINE

(71) Applicants: Philipp Rall, Stuttgart (DE); Joachim Zander, Ilsfeld (DE); Rainer Ottmueller, Bietigheim-Bissingen (DE); Stefan Scheday, Vaihingen (DE)

(72) Inventors: Philipp Rall, Stuttgart (DE); Joachim Zander, Ilsfeld (DE); Rainer Ottmueller, Bietigheim-Bissingen (DE); Stefan Scheday, Vaihingen (DE)

(73) Assignee: MAHLE INTERNATIONAL GMBH, Stuttgart (DE)

(21) Appl. No.: 13/393,874

(22) PCT Filed: Sep. 3, 2010
(86) PCT No.: PCT/DE10/01046

§ 371 Date: Oct. 11, 2012

(30) Foreign Application Priority Data
Sep. 4, 2009 (DE) 10 2009 040 084.2

(51) Int. Cl. B23P 15/10

(52) U.S. Cl. 29/888.049

(57) ABSTRACT

A method for producing a piston for an internal combustion engine, which piston has a piston head, an annular portion and a piston skirt which has two opposite piston pin bosses, shaft recesses being made into the regions of the radially outer end faces of the piston pin bosses during the final machining of the outer surface of the piston blank, the recesses extending in the radial direction. The final machining of the outer surface of the piston blank, including the shaping of the grooves into the annular portion and the shaping of the skirt recesses into the piston skirt, is carried out using a lathe, the position of the turning tool thereof being freely programmable depending on the rotational position of the piston.

The invention relates to a method for the production of a piston for an internal combustion engine, having a piston crown, having a ring belt and having a piston skirt that has two pin bosses that lie opposite one another, with the method steps:

production of a one-part piston blank having regions for the piston skirt and the pin bosses, or of a piston blank consisting of two parts, whereby the one part is intended for the piston crown and the other part is provided for the piston skirt having the pin bosses,

introduction of pin bores into the regions of the pin bosses, and

completion of the piston, whereby within the scope of the final machining of the outer surface of the piston blank, skirt recesses that extend in the radial direction are formed into the regions of the radially outer face surfaces of the pin bosses.

A round-skirt piston of the type stated initially is known from the European patent application EP 0 167 791 A2, having skirt recesses that extend over the entire axial length of the piston skirt in the region of the pin bosses. These recesses are formed into the piston skirt by means of a lathe, whereby the piston is clamped into the lathe eccentrically in its longitudinal direction. It is disadvantageous, in this connection, that using the lathing methods known from the state of the art, it is only possible to produce skirt recesses whose depth decreases continuously toward the edge of the skirt recesses, so that they have an oval shape in cross-section. It is only possible to form a skirt recess that is not oval in cross-section into the piston skirt by using a milling machine, for example by using a circular milling machine, so that for final machining of the piston, not only a conventional lathe but in addition, a milling machine is required, and this makes the production of the piston more expensive, to a not insignificant extent.

It is therefore the task of the present invention to create a simple and price-advantageous method for the production of a piston having skirt recesses, which recesses can be shaped in any desired manner.

This task is accomplished in that the final machining of the outer surface of the piston blank, including forming of the grooves into the ring belt and forming of the skirt recesses into the piston skirt, is undertaken using a lathe, the lathe tool of which can be positioned in freely programmable manner, as a function of the rotational position of the piston.

The use of a lathe, whose lathe tool can be positioned in freely programmable manner, as a function of the rotational position of the piston, makes it possible to restrict oneself, after the production of the piston blank and the introduction of the pin bore, to a single further work step, because using the above lathe, it is possible not only to produce the grooves of the ring belt and skirt recesses that have any desired shape, but also to finish the remainder of the outer piston surface.

Some exemplary embodiments of the invention will be explained in the following, using the drawings. These show:

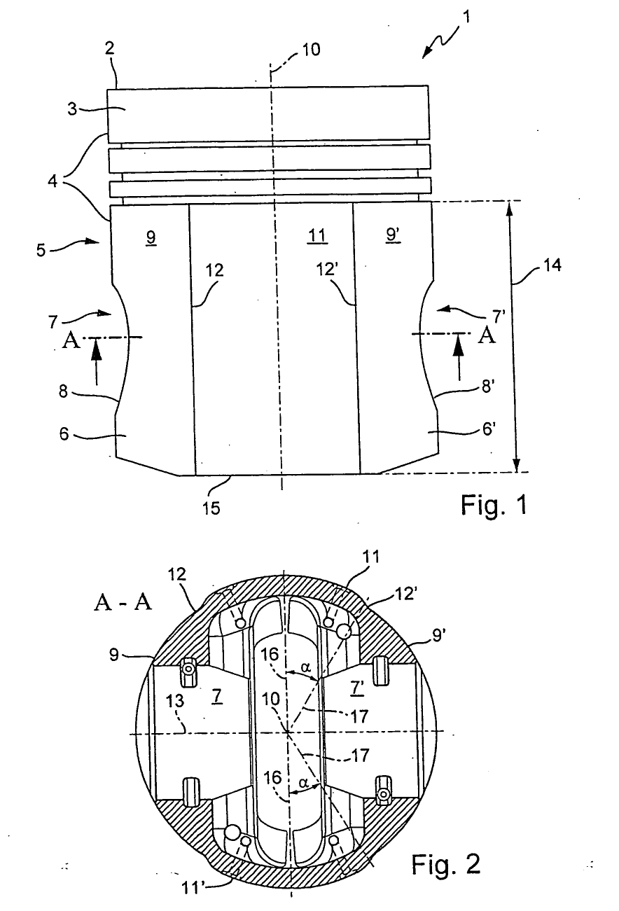

FIG. 1 a piston in a side view, whereby the piston skirt is recessed in the region of the face surfaces of the pin bosses,

FIG. 2 a section through the piston along the line AA in FIG. 1,

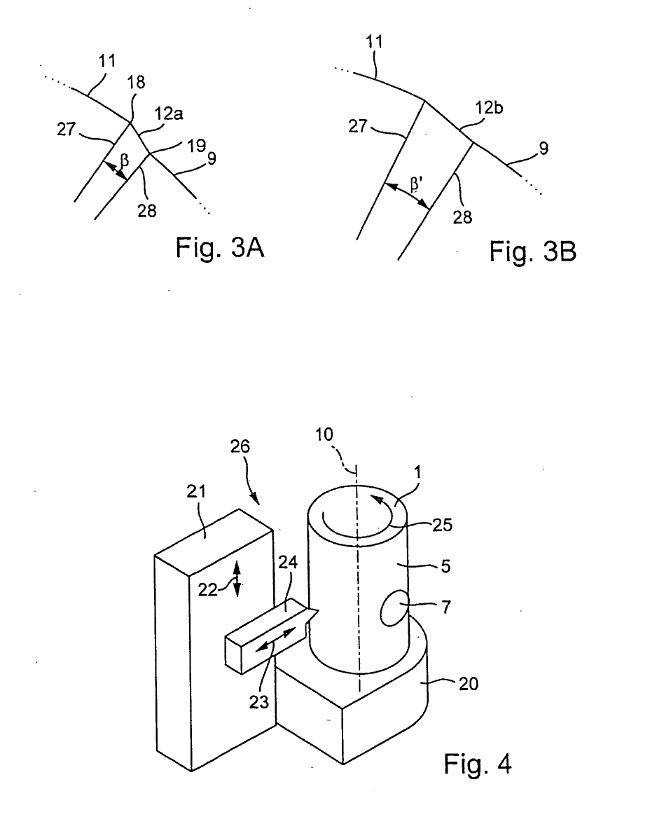

FIG. 3 A, B some embodiments of the transitions between the recessed and the non-recessed skirt regions, and

FIG. 4 a schematic representation of a lathe with freely programmable positioning of the lathe tool.

FIG. 1 shows a piston 1 for an internal combustion engine, which is configured as a round piston, consists of aluminum, and is produced using the forging method. The piston 1 has a piston crown 2, a top land 3, a ring belt 4, and a piston skirt 5 having pin bosses 6, 6′ and pin bores 7, 7′.

In the region of the face surfaces 8, 8′ of the pin bosses 6, 6′, the piston skirt 5 has skirt recesses 9, 9′, in other words the piston skirt is recessed, in these regions, by 0.5 mm to 2 mm in the radial direction, and these regions 9, 9′ thus have a lesser distance from the piston axis 10, by 0.5 to 2 mm, than the non-recessed regions 11, 11′ of the piston skirt 5.

In this connection, the transition regions 12, 12′ between the skirt recesses 9, 9′ and the non-recessed regions 11, 11′ of the piston skirt 5 can lie parallel to one another, as in the present exemplary embodiment according to FIG. 1, or (not shown in FIG. 1) they can narrow conically toward one another in the direction of the piston crown 2. Furthermore, the skirt recesses 9, 9′ can be shaped like the mantle surfaces of a circular cylinder. However, they can also have an oval shape, viewed in cross-section perpendicular to the piston axis 10, whereby the axis 13 of the pin bore 7 (FIG. 2) is the small axis of ovality.

In the present exemplary embodiment, the height 14 of the skirt recess 9, 9′ reaches over the entire axial length of the piston skirt 5, in other words from the ring belt 4 all the way to the lower end 15 of the piston skirt 5, facing away from the piston crown. The height 14 can be freely selected as a function of the production method of the piston 1.

In FIG. 2, a section through the piston 1 along the line AA in FIG. 1, it is shown that the circumferential expanse of the skirt recesses 9, 9′ and of the non-recessed regions 11, 11′ of the piston skirt 5 can be defined using the angle a between a straight line 16 that stands perpendicular on the axis 13 of the pin bore 7 and furthermore perpendicular on the piston axis 10, and a straight line 17 that connects the piston axis 10 with the transition region 12′. In the present exemplary embodiment, the angle a has a value of 32°. However, it can amount to between 5° and 85°.

FIGS. 3 A, B show two embodiments of the transition regions 12a and 12b between the skirt recesses 9 and the non-recessed regions 11 of the piston skirt 5. The transition region 12a according to FIG. 3 A has an edge 18 and 19 that reaches over the entire height 14 of the skirt recess 9, as compared with the regions 9 and 11, in each instance. The transition region 12b according to FIG. 3 B connects the two regions 9 and 11 continuously and without edges.

The circumferential expanse of the transition regions 12a and 12b can be defined by way of the angle β, β′ between straight lines 27, 28 that connect the edges of the regions 11 and 9 with the piston axis 10 (not shown in FIG. 3) and stand perpendicular on the piston axis 10. This angle β, β′ can amount to between 5° and 20°.

Production of a piston blank is known from the state of the art (for example from DE 10 2005 041 000 A1) and will not be explained in any detail here. It should only be noted that the blank is forged using a mandrel for forming the piston interior and a drop forge for forming the external piston shape. Subsequently, the pin bores are introduced using a drilling machine.

The remaining machining of the outer piston surface, such as forming of the grooves of the ring belt 4 and of the skirt recesses 9, 9′ and the final machining of the outer piston surface, takes place by means of a lathe 26 shown schematically. in FIG. 4, the lathe tool 24 of which-can be positioned in freely programmable manner, as a function of the rotational position of the piston 1.

A piston blank 1 attached on the rotary drive 20 so as to rotate is shown. The outer surface of the piston 1, such as the piston skirt 5, for example, can be machined by means of a lathe tool 24 that is attached to an advancing carriage 21 and is mounted so that it can be displaced both in the direction of the arrow 22, parallel to the piston axis 10, and in the direction of the arrow 23, perpendicular to the piston axis 10.

In this connection, the piston blank 1 is put into rotation by the rotary drive 20, in the direction of the rotation arrow 25. The rotational position of the piston blank 1 is determined by way of a rotational position transducer disposed in the rotary drive 20, and reported to a control unit not shown in the figure. The lathe tool 24 is moved toward the piston 1 in the direction of the arrow 23, as a function of the rotational position of the piston blank 1 and of the position of the lathe tool 24, in the direction of the piston axis 10, in order to start cutting removal of material, thereby lathing the skirt recesses and the grooves into the outer surface of the piston blank 1.

The reduction of the surfaces 11, 11′ of the piston skirt 5 that stand in contact with the cylinder interior surface, by means of the skirt recesses 9, 9′, has the advantage of improving the sliding properties of the piston. Furthermore, a round-skirt piston having skirt recesses offers longer pin bores in the radial direction, as compared with a box piston having face surfaces of the pin bosses set back relative to the ring belt, and therefore a greater contact surface area for the piston pin.

Aside from the production of one-part pistons forged from aluminum, the method according to the invention can also be used to produce pistons that consist of two parts, whereby these two parts are either welded, soldered, or screwed to one another. In this connection, the parts can be forged from steel or cast from aluminum or cast iron, whereby each part by itself is finished by lathing it using the lathe 26. The method according to the invention is furthermore suitable for producing the skirt part of articulated pistons. In any case, the method according to the invention is well suited for forming skirt recesses into the piston parts that are intended for the pin bosses.

Furthermore, the method according to the invention has the advantage that the skirt recesses can be shaped in any desired manner. Seen in the direction of the piston axis 10, the transition regions 12 between the skirt recesses 9 and the non-recessed regions 11 of the piston skirt 5 can have any desired shape, and can be configured in wave shape, for example.

### REFERENCE SYMBOL LIST

α, β, β′ angles
1 piston, piston blank
2 piston crown
3 top land
4 ring belt
5 piston skirt
6, 6′ pin boss
7, 7′ pin bore
8, 8′ face surface of the pin boss 6, 6′
9, 9′ skirt recess
10 piston axis
11, 11′ non-recessed region of the piston skirt 5
12, 12′ transition region between the skirt recess 9 and the region 11
12a, 12b transition region between the skirt recess 9 and the region 11
13 axis of the pin bore 7
14 height of the skirt recess 9
15 lower end of the piston skirt 5
16 connection straight line
17 connection straight line
18, 19 edge between the transition region 12a and the skirt recess 9 or the non-recessed region 11 of the piston skirt 5
20 rotary drive
21 advancing carriage
22, 23 arrow
24 lathe tool
25 rotation arrow
26 lathe
27, 28 straight line

1. Method for the production of a piston (1) for an internal combustion engine, having a piston crown (2), having a ring belt (4) and having a piston skirt (5) that has two pin bosses (6, 6′) that lie opposite one another, with the method steps:
production of a one-part piston blank having regions for the piston skirt (5) and the pin bosses (6, 6′), or of a piston blank consisting of two parts, wherein the one part is intended for the piston crown (2) and the other part is provided for the piston skirt (5) having the pin bosses (6, 6′),
introduction of pin bores (7, 7′) into the regions of the pin bosses (6, 6′), and
completion of the piston (1), wherein within the scope of the final machining of the outer surface of the piston blank, skirt recesses that extend in the radial direction are formed into the regions of the radially outer face surfaces (8, 8′) of the pin bosses (6, 6′),
wherein the final machining of the outer surface of the piston blank, including forming of the grooves into the ring belt (4) and forming of the skirt recesses (9, 9′) into the piston skirt (5), is undertaken using a lathe (26), the lathe tool of which can be positioned in freely programmable manner, as a function of the rotational position of the piston (1).

2. Method according to claim 1, wherein the skirt recesses (9, 9′) are produced with a depth between 0.5 mm and 2 mm.

3. Method according to claim 2, wherein transition regions (12a) are formed in between the skirt recesses (9, 9′) and the non-recessed regions (11, 11′) of the piston skirt (5), which regions have an edge (18, 19) that reaches over the entire height (14) of the skirt recess (9, 9′), in each instance, as compared with the skirt recesses (9, 9′) and as compared with the non-recessed regions (11, 11′), and have a flat surface between the edges (18, 19).

4. Method according to claim 2, wherein transition regions (12b) are formed in between the skirt recesses (9, 9′) and the non-recessed regions (11, 11′) of the piston skirt (5), which regions connect the skirt recesses (9, 9′) with the non-recessed regions (11, 11′) of the piston skirt (5), continuously and without edges.

5. Method according to claim 3, wherein the transition regions (12a, 12b) are structured in such a manner that they come to lie parallel to the piston axis (10).

6. Method according to claim 3, wherein the transition regions (12a, 12b) are structured in such a manner that they narrow conically toward one another in the direction of the piston crown (2).

7. Method according to claim 3, wherein the transition regions (12a, 12b) are structured in such a manner that they narrow conically toward one another in the direction of the end (15) of the piston skirt (5) that faces away from the piston crown.
